(19) United States
(12) Patent Application Publication
(10) Pub. No.: US 2022/0095595 A1
(43) Pub. Date: Mar. 31, 2022

(54) BRACKET FOR USE WITH ROUNDED AQUARIUMS AND METHODS

(71) Applicant: SPECTRUM BRANDS, INC., Middleton, WI (US)

(72) Inventor: Bernd Heinz WALLMEIER, (US)

(21) Appl. No.: 17/429,900

(22) PCT Filed: Feb. 11, 2020
(86) PCT No.: PCT/US2020/017690

§ 371 Date: Aug. 10, 2021

Related U.S. Application Data
(60) Provisional application No. 62/804,580, filed on Feb. 12, 2019.

(51) Int. Cl. A01K 63/04

(52) U.S. Cl. CPC A01K 63/047; A01K 63/045

(57) ABSTRACT

A bracket for removable attachment to a round rim of an aquarium allows for secure and stable attachment of an aquarium filter to an aquarium having a round opening. The bracket has a first piece for removable attachment to the round rim and has a pair of lips sized to hold the round rim. The bracket also includes a second piece with a flexible clip removably attached to the first piece.

This application is being filed on 11 Feb. 2020, as a PCT International patent application, and claims priority to U.S. Provisional Patent Application No. 62/804,580, filed Feb. 12, 2019, the disclosure of which is hereby incorporated by reference herein in its entirety.

### TECHNICAL FIELD

This disclosure relates to a mechanism and method for securing an aquarium filter to an aquarium having a round rim.

### BACKGROUND

Aquarium bowls enjoy great popularity in many regions. Often, these spherical aquariums are delivered without filters. In the past, it has been difficult to find a filter that can be attached to the different radii of the aquarium opening, and at the same time, have the filter be positioned steadily (i.e., stable) so that it does not tumble into the aquarium.

Improvements are desirable.

### SUMMARY

A bracket for attaching an aquarium filter to a radiused rim is provided that improves the prior art.

In one aspect, a bracket is provided which has flexibility to attach an aquarium filter to different sized openings, and at the same time, stabilize the filter so it does not wobble due to the movement of the water.

In one aspect, a bracket for removable attachment to a radiused rim of a container is provided and includes a first piece for removable attachment to a radiused rim; the first piece including a pair of lips sized to hold a radiused rim; and a second piece including a flexible clip removably attached to the first piece.

The first piece can include a frame; a pair of lips depending from the frame; and a support wall arrangement extending from the frame and defining a clip-receiving region. The frame has an aperture in open communication with the clip-receiving region, wherein the flexible clip of the second piece is sized to be received within the aperture and oriented within the clip-receiving region of the first piece

The support wall arrangement can be perpendicular to a plane containing the frame.

The second piece may include a wall having a filter engaging side and an opposite clip side, the flexible clip extending from the clip side; and a fastening arrangement along the filter engaging side for removable attachment to a filter.

In some embodiments, the fastening arrangement includes a plurality of vertically aligned peg-receivers to allow for vertical adjustment of a filter.

In one or more arrangements, the second piece wall is at least twice a length of the clip and of the support wall arrangement of the first piece. In some embodiments, the pair of lips are curved and spaced apart from each other to form a rim-engaging receiving volume therebetween; the rim-engaging receiving volume is sized to receive and tightly hold a radiused rim of a thickness than no greater than 2 cm.

In many embodiments, the first piece and the second piece comprise flexible plastic.

In another aspect, a combination of a bracket and an aquarium filter is provided. The combination includes a bracket, as variously characterized above; and an aquarium filter removably attached to the second piece.

The combination can include the aquarium filter having a filter housing with a pump to draw aquarium water into the housing; a filter cartridge within the housing to remove particulate from the water; and spillway to allow the filtered water to exit the filter housing.

In some embodiments, the aquarium filter includes a filter housing having one or more pegs mountable within peg-receivers of the second piece.

In another aspect, a combination of a bracket and an aquarium is provided. The combination includes the bracket as variously characterized above; and an aquarium having a round open rim and an interior volume. The lips of the first piece removably clamp on the rim, and the second piece extends into the interior volume.

The combination of the bracket and aquarium may further comprise an aquarium filter removably attached to the second piece.

In another aspect, a method of providing an aquarium filter for an aquarium having a round open rim is provided. The method includes attaching a first piece of a bracket to the round open rim by engaging a pair of lips over the rim; attaching the aquarium filter to a second piece of the bracket, the second piece of the bracket having a flexible clip; and mounting the flexible clip onto the first piece to allow the aquarium filter to extend into an interior of the aquarium.

The step of attaching a first piece of a bracket can include using a bracket as variously characterized above.

The step of attaching the aquarium filter to a second piece of the bracket can include fitting pegs from the aquarium filter into peg-receivers on the second piece.

Other aspects of this disclosure will become apparent by consideration of the detailed description and accompanying drawings.

### BRIEF DESCRIPTION OF THE DRAWINGS

FIG. 1 is a perspective view of a combination of a bracket, an aquarium, and an aquarium filter, constructed in accordance with principles of this disclosure;

FIG. 2 is a perspective view of the bracket and aquarium filter shown in FIG. 1;

FIG. 3 is an exploded, perspective view of the bracket and aquarium filter of FIG. 2;

FIG. 4 is a cross-sectional view of the bracket and aquarium filter of FIG. 2, and showing schematic fluid flow through the filter;

FIG. 5 is a perspective view of the bracket used with the aquarium filter of FIGS. 1-4;

FIG. 6 is an exploded, perspective view of the bracket of FIG. 5 and showing a first piece and second piece;

FIG. 7 is an upper perspective view of the first piece of the bracket of FIG. 6; and

FIG. 8 is a lower perspective view of the first piece of the bracket of FIG. 6.

### DETAILED DESCRIPTION

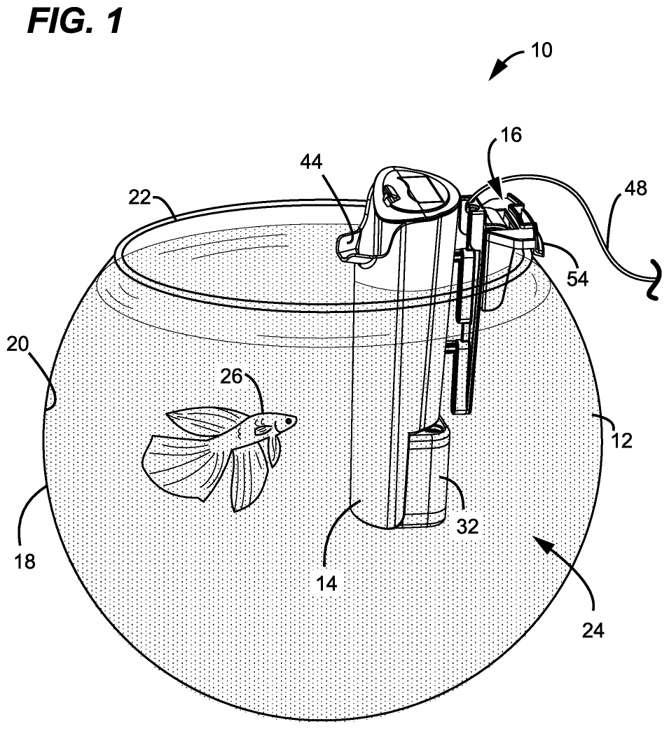

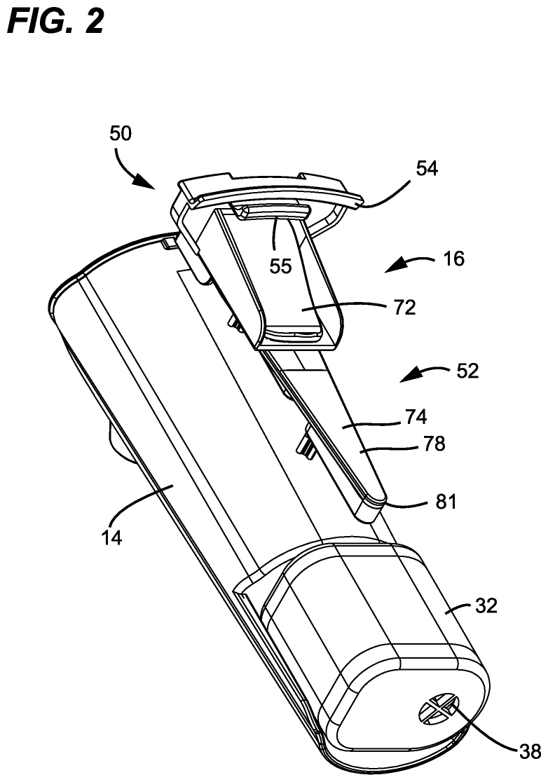

FIG. 1 illustrates a system 10 including a combination of an aquarium 12, an aquarium filter 14, and a bracket 16. The bracket 16 steadily holds the aquarium filter 14 in place within the aquarium 12.

The aquarium 12 is depicted as a “bowl-style” aquarium, in that it has a spherical shaped outer wall 18 made of glass or clear acrylic. An interior volume 20 is contained within the wall 18. A round rim 22 provides open communication with the interior volume 20. In other embodiments, instead of having a spherical outer wall 18, the wall can also be drum style, or any other shape provided that the rim 22 is generally rounded, including oval.

The interior volume 20 holds water 24, in which pet fish 26, or other types of aquatic animals or plants can live.

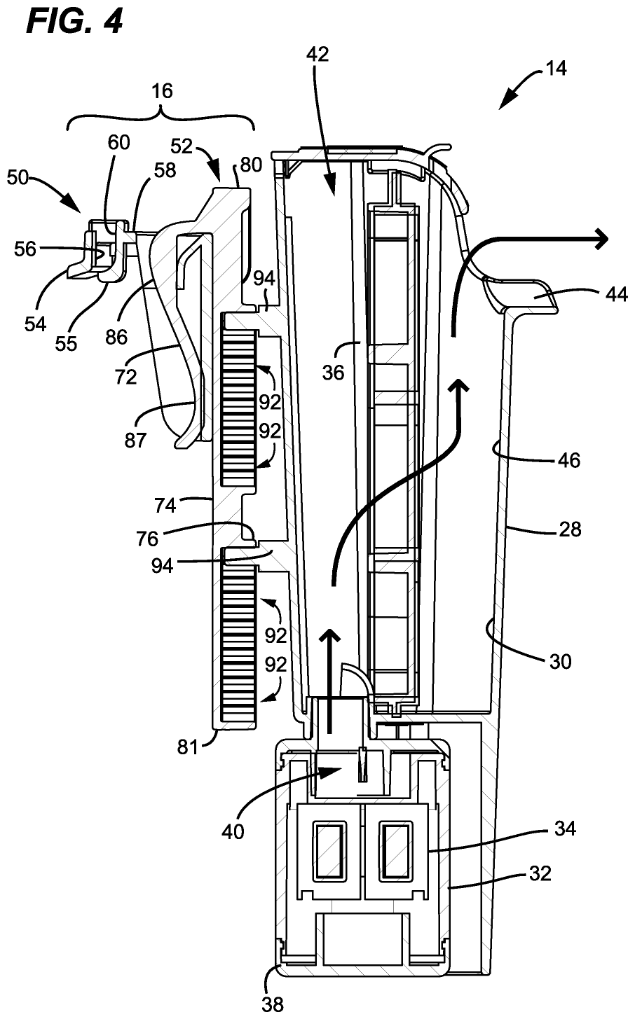

The aquarium filter 14 can be many different types of filters. One useable filter is described in U.S. Pat. No. 6,797,163, incorporated herein by reference. In FIG. 4, the example aquarium filter 14 is shown in cross section. The aquarium filter 14 includes a filter housing 28 having a housing interior 30. Within the housing interior 30 is a pump 32 having a motorized impeller, shown generally at 34. In FIG. 1, a power cord 48 is visible and provides electrical power to the pump 32.

The example aquarium filter 14 further includes a filter cartridge 36 held within the filter interior 30. The filter housing 28 includes an inlet port 38 at the bottom of the housing 28 and a pump outflow port 40 between the pump region and the filtration chamber 42 contained upstream of the filter cartridge 36. A spillway 44 is defined as an opening in a top region of the filter housing 28.

When the aquarium filter 14 is mounted onto the rim 22 of the aquarium 12, the inlet port 28 will be submerged within the water 24, while the spillway 34 will be above the upper level of the water 24. In operation, the water 24 is drawn into the aquarium filter 14 through the inlet port 38 by the pump 32 and through the outlet port 40 into the filtration chamber 42. From there, the water passes through the filter cartridge 36, where particulate and/or any undesired impurities are removed. From there, the filtered water flows into a clean water chamber 46 within the housing interior 30 and then exits the aquarium filter 14 through the spillway 34, where it is returned back into the remaining portion of the interior volume 20 of the aquarium 12.

The bracket 16 allows for removable attachment to the round or radiused rim 22 of a container. In this case, the container is the aquarium 12. The bracket 16 includes a first piece 50 and a second piece 52.

In general, the first piece 50 allows for removable attachment to the radiused rim 22. The second piece 52 is removably attachable to the first piece 50. The second piece 52 is also removably attachable to the aquarium filter 14.

The first piece 50 includes a pair of clamp members, or grips, or grippers or lips 54, 55 (FIG. 8). By “lips”, it is meant structure that forms two spaced members with an opening therebetween, and in this case function to clamp or grip. The lips 54, 55 are curved and spaced apart from each other to form a rim-engaging receiving volume 56 therebetween. The rim-engaging receiving volume 56 is sized to receive and tightly hold the radiused rim 22 of the aquarium 12. Typically, the radiused rim 22 will have a thickness no greater than 2 cm.

The lips 54, 55 can be made of a flexible plastic so that they can elastically flex around the rim 22 to accommodate the rim 22 within the receiving volume 56.

Still in reference to FIG. 8, the lip 54 is an outer lip, and will be on the outside of the rim 22, while the lip 55 is an inner lip and will be on the inside of the rim 22. The lip 54 is longer than the lip 55. As can be seen, the lip 55 is centered within the length of the lip 54. The lip 55 is no more than 80% of the length of the lip 54. The radius of curvature of the lip 54 and lip 55 is preferably about the same. These differences in length between the outer lip 54 and inner lip 55 help contribute to a stable attachment of the bracket 16 to the round rim 22.

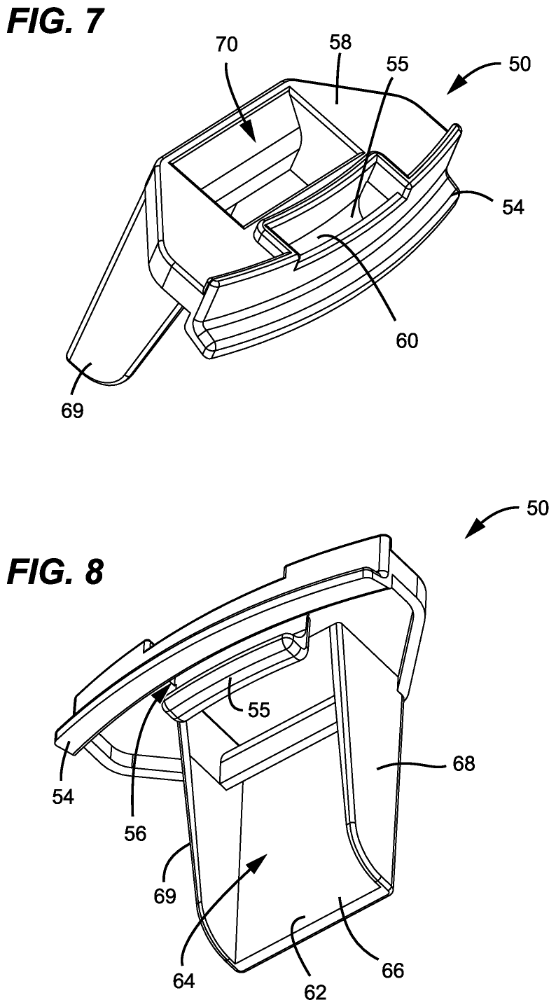

The first piece 50 further includes a frame 58. The lips 54, 55 depend from the frame 58. As can be seen in FIG. 7, a frame 58 defines an opening 60, which separates the outer lip 54 from the inner lip 55. The first piece 50 further includes a support wall arrangement 62. The support wall arrangement. The support wall arrangement 62 is generally perpendicular to a plane containing the frame 58. The support wall arrangement 62 defines a clip-receiving region 64. While a variety of embodiments are possible, in this embodiment, the support wall arrangement 62 includes a center wall 66 and a pair of side walls 68, 69 along each side of the center wall 66.

The frame 58 defines an aperture 70 in open communication with the clip-receiving region 64.

The second piece 52 includes a flexible clip 72. The flexible clip 72 is sized to be received within the aperture 70 of the first piece 50 and oriented within the clip-receiving region 64 in order to removable connect the second piece 52 to the first piece 50.

The second piece 52 includes a wall 74. The wall 74 has a filter engaging side 76 and an opposite clip side 78. The wall 74 has first and second opposite ends 80, 81.

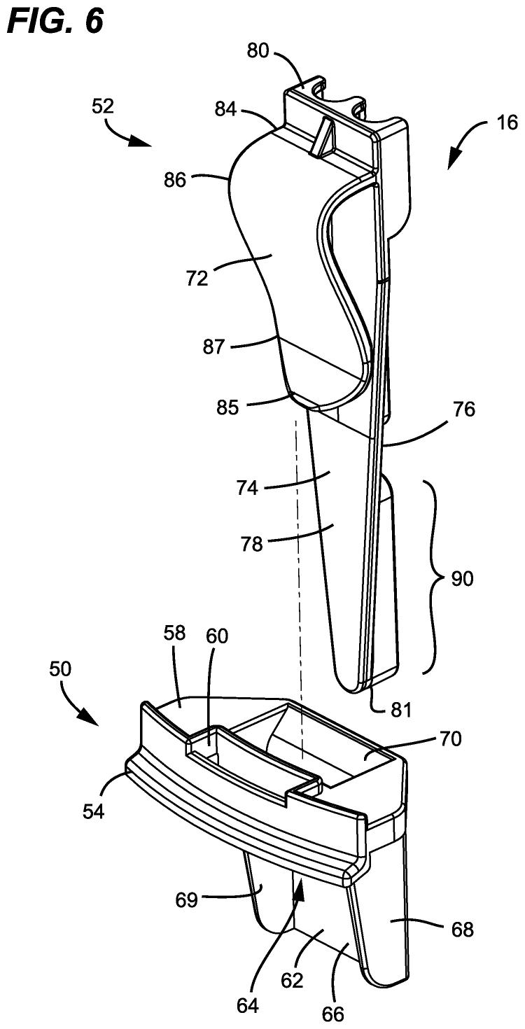

The flexible clip 72 extends from the clip side 78 of the wall 74. As can be seen in FIG. 6, the clip 72 has a fixed end 84 adjacent the first end 80 of the wall 74. The clip 72 has an opposite free end 85. Between the fixed end 84 and free end 85, the clip 72 is shaped in the form of a spring clip, such that there is an outer bend 86 and an inner bend 87. The inner bend 87 is in touching engagement with the clip side 78 of the wall 74, while the outer bend 86 is positioned spaced away from the wall 74. The clip 72 is made from a flexible plastic material, such that the free end 85 can be moved laterally away from the wall 74 in order to penetrate the aperture 70 of the first piece 50 and allow the clip 72 to rest within the clip-receiving region 74 of the first piece 50.

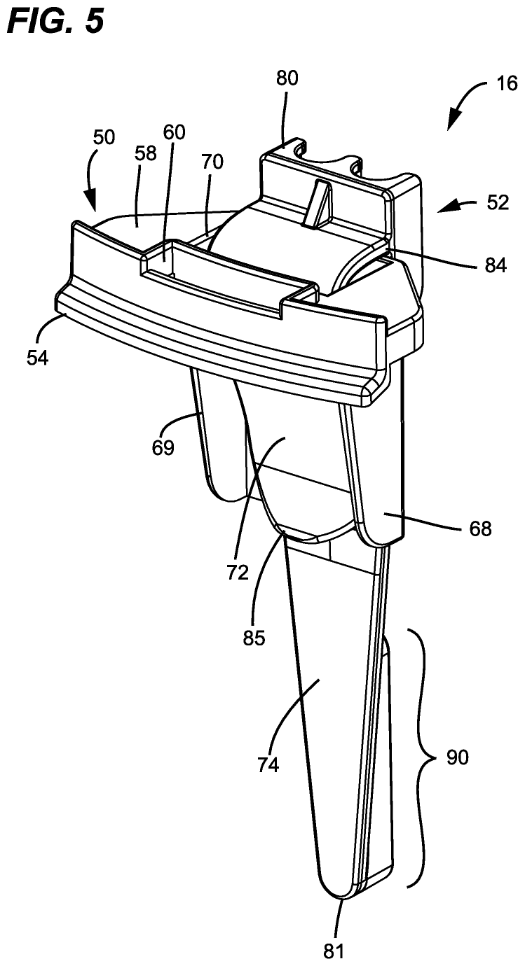

From a review of FIG. 5, it can be appreciated that the second piece wall 74 is at least twice a length of the clip 72 and the support wall arrangement 62 of the first piece 50. The length of the wall 74 is to allow for secure attachment to the aquarium filter 14, as described further below.

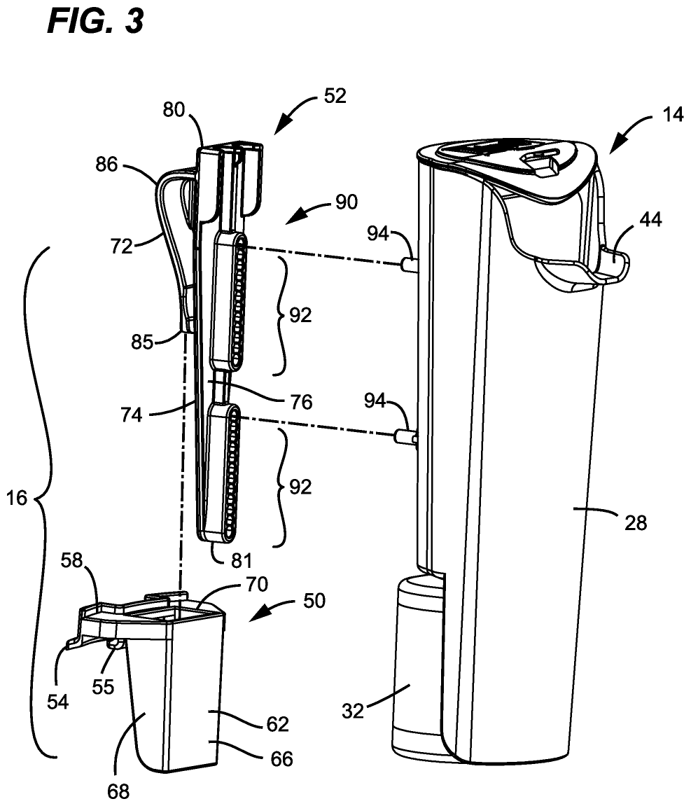

The filter engaging side 76 of the wall 74 includes a fastening arrangement 90 for removable attachment to the aquarium filter 14. While many embodiments are possible, in the example shown, the fastening arrangement 90 includes a plurality of vertically aligned peg-receivers 92. The aquarium filter 14 includes a plurality of pegs 94 (FIGS. 3 and 4) that can be received by the peg receivers 92 for removable attachment of the aquarium filter 14 to the second piece 52 of the bracket 16. Because of the plurality of peg receivers 92, the aquarium filter 14 can be vertically adjusted easily by aligning the pegs 94 to fit within a vertically appropriate peg-receiver 92. Of course, in other embodiments, the second piece 52 could have the pegs 94, while the aquarium filter 14 could have the peg-receivers 92. Many other embodiments are possible.

The bracket 16 can be made from many materials, but convenient materials include the first piece 50 and second piece 52 made from plastic, such as a flexible plastic.

The bracket 16 can be used in a method for providing an aquarium filter for an aquarium having a round open rim. The method includes attaching the first piece 50 of the bracket 16 to the round open rim 22 by engaging the pair of lips 54, 55 over the rim 22.

The method can include attaching the aquarium filter 14 to the second piece 52 of the bracket 16. The second piece 52 of the bracket 16 includes the flexible clip 72.

The method can include mounting the flexible clip 72 onto the first piece 50 to allow the aquarium filter 14 to extend into an interior 20 of the aquarium 12.

The step of attaching the first piece 50 can include using the bracket 16 as characterized herein. The step of attaching the aquarium filter 14 to the second piece 52 includes fitting pegs 94 of the aquarium filter 14 into peg-receivers 92 on the second piece 52.

When servicing of the aquarium filter 14 is needed, the aquarium filter 14 can be easily removed from the aquarium 12 by removing the aquarium filter, attached to the second piece 52 from the first piece 50 by sliding the clip 72 along the center wall 66 in the clip receiving region 64 and then out through the aperture 70 of the first piece 50.

After the aquarium filter 14 is serviced, such as by changing the filter cartridge 36, the aquarium filter 14 can again be installed in the aquarium by sliding the clip 72 through the frame aperture 70 and into the clip receiving region 64. The first piece 50 of the bracket 16 steadily holds the aquarium filter 14 in place and prevents it from falling within the interior volume 20 of the aquarium 12.

The above represents example principles. Many embodiments can be made using these principles.

1. A bracket for removable attachment to a radiussed rim of a container; the bracket comprising:
(a) a first piece for removable attachment to a radiussed rim; the first piece including a pair of lips sized to hold a radiussed rim; and
(b) a second piece including a flexible clip removably attached to the first piece.

2. The bracket of claim 1 wherein the first piece includes:
(a) a frame; the pair of lips depending from the frame; and
(b) a support wall arrangement extending from the frame and defining a clip-receiving region; the frame having an aperture in open communication with the clip-receiving region, wherein the flexible clip of the second piece is sized to be received within the aperture and oriented within the clip-receiving region of the first piece.

3. The bracket of claim 2 wherein the support wall arrangement is perpendicular to a plane containing the frame.

4. The bracket of claim 2 wherein the second piece includes:
(a) a wall having a filter engaging side and an opposite clip side;
(b) the flexible clip extending from the clip side; and
(c) a fastening arrangement along the filter engaging side for removable attachment to a filter.

5. The bracket of claim 4 wherein the fastening arrangement includes a plurality of vertically aligned peg-receivers to allow for vertical adjustment of a filter.

6. The bracket of claim 4 wherein the second piece wall is at least twice a length of the clip and of the support wall arrangement of the first piece.

7. The bracket of claim 1 wherein the pair of lips are curved and spaced apart from each other and form a rim-engaging receiving volume therebetween; the rim-engaging receiving volume being sized to receive and tightly hold a radiussed rim of a thickness no greater than 2 cm.

8. The bracket of claim 1 wherein the first piece and the second piece comprise flexible plastic.

9. A combination of a bracket and an aquarium filter, the combination comprising:
(a) a bracket including a first piece for removable attachment to a radiussed rim; the first piece including a pair of lips sized to hold a radiussed rim; and a second piece including a flexible clip removably attached to the first piece;
(b) an aquarium filter removably attached to the second piece.

10. The combination of claim 9 wherein the aquarium filter comprises a filter housing having a pump to draw aquarium water into the housing, a filter cartridge within the housing to remove particulate from the water, and a spillway to allow the filtered water to exit the filter housing.

11. The combination of claim 9 wherein the fastening arrangement includes a plurality of vertically aligned peg-receivers to allow for vertical adjustment of a filter and, wherein the aquarium filter includes a filter housing having one or more pegs mountable with the peg-receivers of the second piece.

12. A combination of a bracket and an aquarium, the combination comprising:
(a) a bracket including a first piece for removable attachment to a radiussed rim; the first piece including a pair of lips sized to hold a radiussed rim; and a second piece including a flexible clip removably attached to the first piece; and
(b) an aquarium having a round open rim and an interior volume; the lips of the first piece removably clamped on the rim; and the second piece extending into the interior volume.

13. The combination of claim 12 and further comprising an aquarium filter removably attached to the second piece.

14. A method of providing an aquarium filter for an aquarium having a round open rim; the method comprising:
(a) attaching a first piece of a bracket to the round open rim by engaging a pair of lips over the rim;
(b) attaching the aquarium filter to a second piece of the bracket, the second piece of the bracket having a flexible clip; and
(c) mounting the flexible clip onto the first piece to allow the aquarium filter to extend into an interior of the aquarium.

15. The method of claim 14 wherein the step of attaching a first piece of a bracket includes using a bracket including a first piece for removable attachment to a radiussed rim; the first piece including a pair of lips sized to hold a radiussed rim; and a second piece including a flexible clip removably attached to the first piece.

16. The method of claim 14 wherein the step of attaching the aquarium filter to a second piece of the bracket includes fitting pegs from the aquarium filter into peg-receivers on the second piece.
